(19) United States
(12) Patent Application Publication
(10) Pub. No.: US 2023/0299349 A1
(43) Pub. Date: Sep. 21, 2023

(54) ELECTROLYTE COMPOSITION AND LITHIUM BATTERY INCLUDING THE SAME

(71) Applicant: Electronics and Telecommunications Research Institute, Daejeon (KR)

(72) Inventors: Jaecheol CHOI, Daejeon (KR); Kwang Man KIM, Daejeon (KR); Young-Gi LEE, Daejeon (KR); Seok Hun KANG, Daejeon (KR); Ju Young KIM, Daejeon (KR); Dong Ok SHIN, Daejeon (KR); Jimin OH, Daejeon (KR)

(73) Assignee: Electronics and Telecommunications Research Institute, Daejeon (KR)

(21) Appl. No.: 18/084,253

(22) Filed: Dec. 19, 2022

(30) Foreign Application Priority Data
Mar. 3, 2022 (KR) 10-2022-0027548
May 30, 2022 (KR) 10-2022-0066005

(51) Int. Cl. H01M 10/0567; H01M 10/052

(52) U.S. Cl. CPC H01M 10/0567; H01M 10/052

(57) ABSTRACT

A lithium battery according to the inventive concept includes: a first electrode structure; a second electrode structure separated from the first electrode structure; and an electrolyte between the first electrode structure and the second electrode structure, wherein the electrolyte includes: a lithium salt; an organic solvent; and an additive, the additive includes a polymer additive, and the polymer additive may be a mixture of at least two or more polymers among a halogen-based polymer, a silicon-based polymer and an acrylic polymer, or a copolymer thereof.

### CROSS-REFERENCE TO RELATED APPLICATIONS

This U.S. non-provisional Pat. application claims priority under 35 U.S.C. § 119 of Korean Patent Application Nos. 10-2022-0027548, filed on Mar. 3, 2022, and 10-2022-0066005, filed on May 30, 2022, the entire contents of which are hereby incorporated by reference.

### BACKGROUND

The present disclosure herein relates to a lithium battery and more particularly, to an electrolyte composition of a lithium battery.

Secondary batteries may include lithium batteries. Recently, the applicability of lithium batteries is expanded. For example, lithium batteries are widely used as power sources of electric vehicles (EV) and energy storage systems (ESS). If the amount of a flame retardant increases, there may be problems concerning costs and performance.

Recently, there are attempts to improve liquid electrolyte/separator systems in a lithium battery. However, it is judged that it will take a long time for a solid electrolyte to be commercialized due to relatively low ionic conductivity, instability and large internal resistance. Accordingly, research on a method for improving the safety of a liquid electrolyte while maintaining a lithium battery system based on a liquid electrolyte without reducing cell performance is being continued.

### SUMMARY

A technical task for solving in the present disclosure is to provide an electrolyte composition having improved thermal safety properties and electrochemical properties, and a lithium battery electrolyte including the same.

Another technical task for solving in the present disclosure is to provide a lithium battery having improved electrochemical properties.

The tasks to be solved by the inventive concept is not limited to the above-described tasks, however other tasks not mentioned will be precisely understood from the description below by a person skilled in the art.

The present disclosure relates to an electrolyte composition and a lithium battery including the same. According to the inventive concept, a lithium battery includes: a first electrode structure; a second electrode structure separated from the first electrode structure; and an electrolyte between the first electrode structure and the second electrode structure, wherein the electrolyte includes: a lithium salt; an organic solvent; and an additive, the additive includes a polymer additive, and the polymer additive is a mixture of at least two or more polymers among a halogen-based polymer, a silicon-based polymer and an acrylic polymer, or a copolymer thereof.

In an embodiment, the halogen-based polymer may be a polymer in which at least one hydrogen atom of a polyolefin polymer main chain is substituted with at least one among F, Cl, Br and I, or a copolymer thereof, the silicon-based polymer may be a polymer including a main chain of a polysiloxane type, or a copolymer thereof, and the acrylic polymer may be a polymer including acrylate in a unit, or a copolymer thereof.

In an embodiment, the silicon-based polymer may be represented by Formula 1.

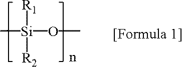

In Formula 1, R₁ and R₂ may be each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

In an embodiment, the acrylic polymer may be represented by Formula 2.

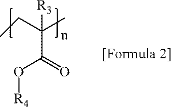

In Formula 2, R₃ and R₄ may be each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

In an embodiment, a composition ratio of the polymer additive may be from about 0.1 wt% to about 30 wt% of the electrolyte.

In an embodiment, a molecular weight of the polymer additive may be from about 500 g/mol to about 10,000,000 g/mol.

In an embodiment, the polymer additive may be added in a powder type to the electrolyte.

In an embodiment, the additive may further include an auxiliary agent, and the auxiliary agent may be at least one of ethylene carbonate or vinylene carbonate or combination thereof.

In an embodiment, the first electrode structure may include a first collector and a first electrode layer on the first collector, and the first electrode layer may be provided between the first collector and the electrolyte.

In an embodiment, the second electrode structure may include a second collector and a second electrode layer on the second collector, and the second electrode layer may be provided between the second collector and the electrolyte.

In an embodiment, the lithium battery may further include a separator between the first electrode structure and the second electrode structure, and the electrolyte may be provided between the first electrode structure and the separator, and between the second electrode structure and the separator.

According to embodiments of the inventive concept, an electrolyte composition includes: a lithium salt; an organic solvent; and an additive, wherein the additive includes a polymer additive, the polymer additive is a mixture of at least two or more polymers among a halogen-based polymer, a silicon-based polymer and an acrylic polymer, or a copolymer thereof.

In an embodiment, the halogen-based polymer may be a polymer in which at least one hydrogen atom of a polyolefin polymer main chain is substituted with at least one among F, Cl, Br and I, or a copolymer thereof, the silicon-based polymer may be a polymer including a main chain of a polysiloxane type, or a copolymer thereof, and the acrylic polymer may be a polymer including acrylate in a unit, or a copolymer thereof.

In an embodiment, the silicon-based polymer may be represented by Formula 1.

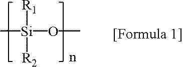

In Formula 1, R₁ and R₂ may be each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

In an embodiment, the acrylic polymer may be represented by Formula 2.

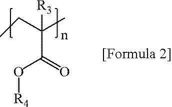

In Formula 2, R₃ and R₄ may be each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

In an embodiment, a composition ratio of the polymer additive in the electrolyte composition may be from about 0.1 wt% to about 30 wt%.

In an embodiment, a molecular weight of the polymer additive may be from about 500 g/mol to about 10,000,000 g/mol.

In an embodiment, the polymer additive may be added in a powder type.

In an embodiment, the additive may further include an auxiliary agent, and the auxiliary agent may be at least one of ethylene carbonate or vinylene carbonate thereof.

In an embodiment, the polymer additive may include at least one of a vinylidenefluoride-hexafluoropropylene copolymer (p(VDF-co-HFP)), polymethylmethacrylate (PMMA), polydimethylsiloxane (PDMS), vinylidenefluoride-trifluoroethylene copolymer (p(VDF-TrFE)), or vinylidenefluoride-trifluoroethylene-chlorotrifluoroethylene copolymer (p(VDF-TrFE-CTFE)) or combination thereof.

### BRIEF DESCRIPTION OF THE FIGURES

The accompanying drawings are included to provide a further understanding of the inventive concept and are incorporated in and constitute a part of this specification. The drawings illustrate embodiments of the inventive concept and, together with the description, serve to explain principles of the inventive concept. In the drawings:

FIG. 1 is a cross-sectional view showing a lithium battery according to an embodiment of the inventive concept;

FIG. 2 is a diagram for explaining an electrolyte according to embodiments, and is an enlarged diagram of region A in FIG. 1;

FIG. 3 is a diagram for explaining the ionic conductivity evaluation of the electrolyte compositions of Comparative Example 1, Experimental Example 1, Experimental Example 2, Experimental Example 3, Experimental Example 4, Experimental Example 5 and Experimental Example 6, and is a graph showing ionic conductivity according to the introduction of a polymer additive;

FIG. 4 is a diagram for explaining the electrochemical stability evaluation of the electrolyte compositions of Comparative Example 1, Experimental Example 1, Experimental Example 2, Experimental Example 3, Experimental Example 4, Experimental Example 5 and Experimental Example 6, and is a graph showing current density in accordance with voltages for each electrolyte composition;

FIG. 5 is a diagram for explaining the initial charge and discharge performance property evaluation of the lithium batteries of Comparative Example 1, Experimental Example 1, Experimental Example 2, Experimental Example 3, Experimental Example 4, Experimental Example 5 and Experimental Example 6, and is a graph showing voltages in accordance with discharge capacity of lithium batteries;

FIG. 6 is a diagram for explaining the output property evaluation of the lithium batteries of Comparative Example 1, Experimental Example 1, Experimental Example 2, Experimental Example 3, Experimental Example 4, Experimental Example 5 and Experimental Example 6, and is a graph showing capacity in accordance with cycle numbers; and

FIG. 7 is a diagram for explaining the cycle life property evaluation the lithium batteries of Comparative Example 1, Experimental Example 1, Experimental Example 2, Experimental Example 3, Experimental Example 4, Experimental Example 5 and Experimental Example 6, and is a graph showing capacity in accordance with cycle numbers.

### DETAILED DESCRIPTION

In order to sufficiently understand the configuration and effects of the inventive concept, preferred embodiments of the inventive concept will be explained with reference to accompanying drawings. However, the inventive concept is not limited to the embodiments disclosed hereinbelow and may be accomplished by various types, and various changes may be made. The disclosure of the inventive concept may, however, be completed through the explanation on the embodiments, and the embodiments are provided to completely notify a person having ordinary skill in this technical field in which the inventive concept belongs to of the scope of the inventive concept. A person having ordinary skill in this technical field may understand where the inventive concept could be conducted under what suitable environments.

The terminology used herein is for the purpose of describing particular embodiments only and is not intended to be limiting of the invention. As used herein, the singular forms, are intended to include the plural forms as well, unless the context clearly indicates otherwise. It will be further understood that the terms “comprises” and/or “comprising”, when used in this specification, specify the presence of stated elements, steps, operations, and/or devices, but do not preclude the presence or addition of one or more other elements, steps, operations, and/or devices.

It will be understood that when a film (or layer) is referred to as being “on” another film (or layer), the film (or layer) can be directly on the other film (or layer), or intervening films (or layers) may be present.

In various embodiments described in the present disclosure, the terms first, second, third, etc. are used to describe various regions, films (or layers), etc., but these regions, films should not be limited by these terms. These terms are used only to distinguish a certain region or film (or layer) from another region or film (or layer). Accordingly, a film material referred to as a first film material in an embodiment may be termed a second film material. Each embodiment explained and illustrated herein includes a complementary embodiment. Like reference numerals refer to like elements throughout.

In this document, “A or B”, “at least one of A and B”, “at least one of A or B”, “A, B or C”, “at least one of A, B and C”, and “A Each of the phrases such as “at least one of, B, or C” may include any one of the items listed together in the corresponding phrase, or all possible combinations thereof.

The terms used in the embodiments of the inventive concept may be interpreted as commonly known meanings to a person skilled in the art unless otherwise defined.

Hereinafter, referring to accompanying drawings, an electrolyte material, a lithium battery electrolyte, and a lithium battery according to the inventive concept will be explained.

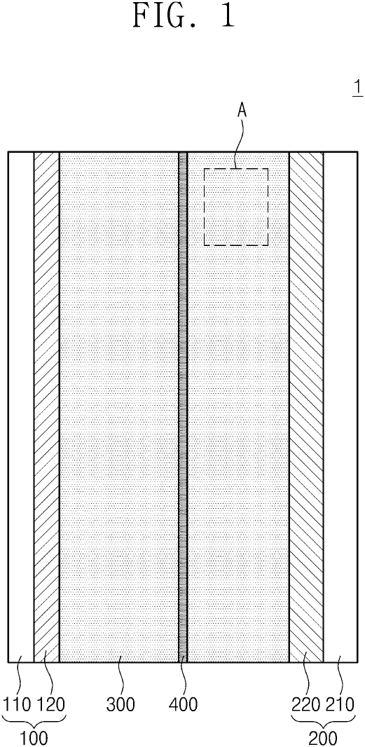

FIG. 1 is a cross-sectional view showing a lithium battery according to an embodiment of the inventive concept.

Referring to FIG. 1, a lithium battery 1 may include a first electrode structure 100, a second electrode structure 200, and an electrolyte 300. The lithium battery 1 may further include a separator 400.

The first electrode structure 100 may include a first collector 110 and a first electrode layer 120. The first electrode structure 100 may play the role of a cathode. The first collector 110 may include a metal such as aluminum (Al). The first electrode layer 120 may be disposed on the first collector 110. The first electrode layer 120 may be electrically connected with the first collector 110. The first electrode layer 120 may include a cathode active material, a conductive material, and a binder. The cathode active material may include, for example, at least one among sulfur, LiCoO₂, LiNiO₂, LiNiₓCo_{y}Mn_{z}O₂ (x, y, z are real numbers of 0 or more, x+y+z=1) (hereinafter, NCM), LiMn₂O₄, and LiFePO₄. For example, the binder may include a fluorine-based polymer such as polyvinylidene fluoride (PVdF). The conductive material may include a carbon-containing material such as conductive amorphous carbon, carbon nanotube, and/or graphene. The first electrode layer 120 includes the binder and the conductive material, and the mechanical bonding strength and electroconductivity of the first electrode layer 120 may be improved. For example, the weight ratio of the active material: binder: conductive material in the first electrode layer 120 may be about 80:10:10 to about 98:1:1.

The second electrode structure 200 may be separated from the first electrode structure 100 and may face thereto. The second electrode structure 200 may include a second collector 210 and a second electrode layer 220. The second electrode structure 200 may play the role of an anode. The second electrode layer 220 may be disposed between the second collector 210 and the first electrode layer 120. The second collector 210 may include a metal such as copper (Cu). The second electrode layer 220 may be disposed on the second collector 210. The second electrode layer 220 may be electrically connected with the second collector 210. The second electrode layer 220 may include an anode active material and a second binder. The anode active material may include a carbon-based material (for example, natural graphite and/or synthetic graphite) or a noncarbon-based material (for example, silicon, silicon oxide, and/or a lithium metal). The second binder may include a cellulose-based binder and/or an organic binder. The second binder may include, for example, at least one among cellulose (carboxymethyl cellulose, CMC), styrene-butadiene rubber (SBR), emulsion and polyvinylidene fluoride (PVdF). For example, the weight ratio of the active material: the second binder in the second electrode layer 220 may be about 80:20 to about 98:2.

A separator 400 may be disposed between the first electrode structure 100 and the second electrode structure 200. The separator may be provided between the first electrode layer 120 and the second electrode layer 220, and may be separated from the first electrode layer 120 and the second electrode layer 220. The separator 400 may include a base layer and a coating layer. The base layer may include a polymer. For example, the base layer may include at least one of polyolefin such as polyethylene and/or polypropylene, and cellulose. The separator may include a porous polymer layer or a non-woven fabric. The coating layer may cover the base layer. In an embodiment, the coating layer may include an inorganic material such as Al₂O₃, TiO₂, and/or SiO₂. In another embodiment, the coating layer may include cellulose (carboxymethyl cellulose, CMC), styrene-butadiene rubber (SBR), polyvinylidene fluoride (PVdF), and/or mixtures thereof. In another embodiment, the coating layer may include an inorganic material and an organic material.

An electrolyte 300 may be disposed between the first electrode structure 100 and the second electrode structure 200. For example, the electrolyte 300 may be disposed between the first electrode layer 120 and the second electrode layer 220. The electrolyte 300 may fill up a gap region between the first electrode layer 120 and the separator 400, and a gap region between the second electrode layer 220 and the separator 400. Ions may move between the first electrode structure 100 and the second electrode structure 200 through the electrolyte 300. The ions may be lithium ions. Hereinafter, an electrolyte according to an embodiment will be explained in more detail.

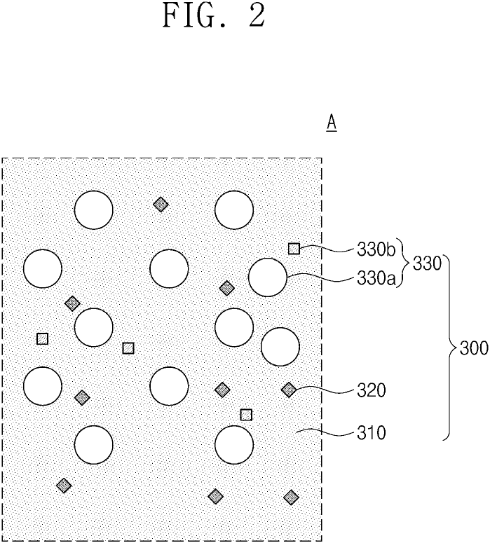

FIG. 2 is a diagram for explaining an electrolyte according to embodiments, and is an enlarged diagram of region A in FIG. 1. Hereinafter, overlapping contents as the explanation above will be omitted.

Referring to FIG. 2, an electrolyte 300 may include an electrolyte composition. The electrolyte 300 may include a liquid electrolyte. The electrolyte composition may include an organic solvent 310, a lithium salt 320, and an additive 330.

The organic solvent 310 may include at least one among linear carbonate and cyclic carbonate. The linear carbonate may include, for example, at least one among dimethyl carbonate, diethyl carbonate, ethyl methyl carbonate, dimethoxyethane, and dimethyl ethylene carbonate. The cyclic carbonate may include, for example, at least one among gamma-butyrolactone (γ-butyrolactone), ethylene carbonate, propylene carbonate, glycerin carbonate, vinylene carbonate and fluoroethylene carbonate.

The lithium salt 320 may include at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BOₛ. The concentration of the lithium salt 320 may be from about 1 M to about 3 M based on the electrolyte 300.

The additive 330 may include a polymer additive 330a. The polymer additive 330a may include a mixture of at least two or more polymers among a halogen-based polymer, a silicon-based polymer and an acrylic polymer, or a copolymer thereof. The composition ratio of the polymer additive 330a may be from about 0.1 to about 30 wt% based on the electrolyte 300. The molecular weight of the polymer additive 330a may be from about 500 g/mol to about 10,000,000 g/mol.

The halogen-based polymer may include a polymer in which at least one hydrogen atom of a polyolefin polymer main chain is substituted with at least one among F, Cl, Br and I, or a copolymer thereof. For example, the halogen-based polymer may include at least one among polyvinylidene fluoride (PVDF), poly(hexafluoropropylene) and a vinylidenefluoride-hexavluoropropylene copolymer (p(VDF-co-HEP)). The composition ratio of the halogen-based polymer may be about 0.1 to about 10 wt% based on the electrolyte 300.

The silicon-based polymer may include a polymer including a main chain of a polysiloxane type, or a copolymer thereof. The silicon-based polymer may be represented by [Formula 1] below. The silicon-based polymer may be, for example, polydimethylsiloxane (PDMS). The composition ratio of the silicon-based polymer may be about 0.1 to about 10 wt% based on the electrolyte 300.

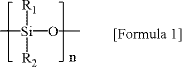

In Formula 1, R₁ and R₂ may be each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

The acrylic polymer may include a polymer including acrylate in a unit, or a copolymer thereof. The acrylic polymer may be represented by [Formula 2] below. The acrylic polymer may be, for example, polymethylmethacrylate (PMMA). The composition ratio of the acrylic polymer may be about 0.1 to about 10 wt% based on the electrolyte 300.

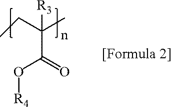

In Formula 2, R₃ and R₄ may be each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

The halogen-based polymer, the silicon-based polymer and the acrylic polymer have excellent dissolution properties, and may be uniformly dissolved even though added in a powder type to the electrolyte 300 that is a liquid. The halogen-based polymer may be electrochemically stable, and halogen may selectively capture and remove oxygen or hydrogen radicals during the decomposition of the polymer. Accordingly, the stability of a lithium battery 1 including the same may be improved. The silicon-based polymer may not be decomposed even though the temperature increases to about 300° C., and may show thermal stability. The acrylic polymer has excellent miscibility and compatibility with a liquid electrolyte, and even though the temperature of a liquid electrolyte increases, volatilization and decomposition may be suppressed.

Since the polymer additive 330a may include the mixture of at least two or more polymers among the halogen-based polymer, the silicon-based polymer and the acrylic polymer, or the copolymer, the polymer additive 330a may be selected according to the use of the lithium battery 1 considering the properties of each polymer.

The additive 330 may further include an auxiliary agent 330b. For example, the auxiliary agent 330b may include at least one among ethylene carbonate and vinylene carbonate. The auxiliary agent 330b may improve the performance of the lithium battery 1.

Hereinafter, the preparation of an electrolyte composition, and the manufacture of a lithium battery will be explained referring to the Experimental Examples of the inventive concept.

### Manufacture of Lithium Battery and Evaluation of Electrolyte Composition and Lithium Battery

### 1. Comparative Example 1

### Manufacture of Lithium Battery

(Manufacture of first electrode structure) The composition of a cathode plate was fixed to a weight ratio of NCM811 active material: binder: conductive agent to about 96:2:2.

(Manufacture of a second electrode structure) SBR and CMC were mixed in a weight ratio of about 1:1 to prepare a SBR/CMC binder. The composition of an anode plate was fixed to a weight ratio of natural graphite active material with the SBR/CMC binder to about 98:2.

(Preparation of electrolyte composition) A mixture was prepared by adding about 1.3 M of a lithium salt (LiPF₆) to an organic solvent obtained by mixing ethylene carbonate and ethyl methyl carbonate in a weight ratio of about 3: 7. An additive was not included.

(Manufacture of lithium battery) The thickness and loading of an electrode was determined with the N/P ratio between the anode structure and the cathode structure of about 1.02. A cell of a 1700 mAh rate was manufactured into a pouch type with a standard of 7.5 cm.10 cm.

### Evaluation

(Evaluation of electrolyte composition) The ionic conductivity of the electrolyte composition of Comparative Example 1 was evaluated.

(Evaluation of lithium battery) The electrochemical stability, charge and discharge performance, output properties and life characteristics of Comparative Example 1 were evaluated. The electrochemical stability was evaluated while increasing the voltage from about 0 V to about 6 V with a scan rate of about 2 mV s⁻¹. The charge and discharge performance was evaluated by performing charge and discharge of about 0.1 C (170 mA) in a charge and discharge voltage range of about 3.0 V to about 4.2 V. For evaluating the output properties, charge and discharge were performed by 5 cycles at a current of about 0.1 C (170 mA), 0.2 C (340 mA), 0.5 C (850 mA), 1 C (1700 mA) and 2 C (3400 mA) in a charge and discharge voltage range of about 3.0 V to about 4.2 V. Then, the current was reduced to about 0.1 C (170 mA), and capacitance retention in contrast to initial 0.1 C (170 mA) was compared and evaluated. The life characteristic were evaluated by performing charge and discharge for 150 cycles with a current of about 0.5 C (850 mA) in a charge and discharge voltage range of about 3.0 V to about 4.2 V.

### 2. Experimental Example 1

### Manufacture of Lithium Battery

(Preparation of electrolyte composition) An electrolyte composition was prepared by adding about 3 wt% of a vinylidenefluoride-hexafluoropropylene copolymer (p(VDF-co-HFP)) to the same electrolyte composition of Comparative Example 1.

(Manufacture of lithium battery) A lithium battery was manufactured by the same method as in Comparative Example 1 except for using the electrolyte composition above as the electrolyte composition.

### Evaluation

(Evaluation of electrolyte composition) The ionic conductivity of the electrolyte composition prepared in Experimental Example 1 was evaluated.

(Evaluation of lithium battery) The electrochemical stability, charge and discharge performance, output properties and life characteristics of the lithium battery manufactured in Experimental Example 1 were evaluated. The evaluation methods were the same as in Comparative Example 1.

### 3. Experimental Example 2

### Manufacture of Lithium Battery

(Preparation of electrolyte composition) An electrolyte composition was prepared by adding about 2 wt% of a vinylidenefluoride-hexafluoropropylene copolymer (p(VDF-co-HFP)) and about 1 wt% of polymethylmthacrylate (PMMA) to the same electrolyte composition of Comparative Example 1.

(Manufacture of lithium battery) A lithium battery was manufactured by the same method as in Comparative Example 1 except for using the electrolyte composition above as the electrolyte composition.

### Evaluation

(Evaluation of electrolyte composition) The ionic conductivity of the electrolyte composition prepared in Experimental Example 2 was evaluated.

(Evaluation of lithium battery) The electrochemical stability, charge and discharge performance, output properties and life characteristics of the lithium battery manufactured in Experimental Example 2 were evaluated. The evaluation methods were the same as in Comparative Example 1.

### 4. Experimental Example 3

### Manufacture of Lithium Battery

(Preparation of electrolyte composition) An electrolyte composition was prepared by adding about 2 wt% of a vinylidenefluoride-hexafluoropropylene copolymer (p(VDF-co-HFP)) and about 1 wt% of polydimethoxysiloxane (PDMS) to the same electrolyte composition of Comparative Example 1.

(Manufacture of lithium battery) A lithium battery was manufactured by the same method as in Comparative Example 1 except for using the electrolyte composition above as the electrolyte composition.

### Evaluation

(Evaluation of electrolyte composition) The ionic conductivity of the electrolyte composition prepared in Experimental Example 3 was evaluated.

(Evaluation of lithium battery) The electrochemical stability, charge and discharge performance, output properties and life characteristics of the lithium battery manufactured in Experimental Example 3 were evaluated. The evaluation methods were the same as in Comparative Example 1.

### 5. Experimental Example 4

### Manufacture of Lithium Battery

(Preparation of electrolyte composition) An electrolyte composition was prepared by adding about 2 wt% of a vinylidenefluoride-hexafluoropropylene copolymer (p(VDF-co-HFP)), about 0.5 wt% of polymethylmethacrylate (PMMA) and about 0.5 wt% of polydimethylmthacrylate (PDMS) to the same electrolyte composition of Comparative Example 1.

(Manufacture of lithium battery) A lithium battery was manufactured by the same method as in Comparative Example 1 except for using the electrolyte composition above as the electrolyte composition.

### Evaluation

(Evaluation of electrolyte composition) The ionic conductivity of the electrolyte composition prepared in Experimental Example 4 was evaluated.

(Evaluation of lithium battery) The electrochemical stability, charge and discharge performance, output properties and life characteristics of the lithium battery manufactured in Experimental Example 4 were evaluated. The evaluation methods were the same as in Comparative Example 1.

### 6. Experimental Example 5

### Manufacture of Lithium Battery

(Preparation of electrolyte composition) An electrolyte composition was prepared by adding about 2 wt% of a vinylidenefluoride-trifluoroethylene copolymer (p(VDF-TrFE)) to the same electrolyte composition of Comparative Example 1.

(Manufacture of lithium battery) A lithium battery was manufactured by the same method as in Comparative Example 1 except for using the electrolyte composition above as the electrolyte composition.

### Evaluation

(Evaluation of electrolyte composition) The ionic conductivity of the electrolyte composition prepared in Experimental Example 5 was evaluated.

(Evaluation of lithium battery) The electrochemical stability, charge and discharge performance, output properties and life characteristics of the lithium battery manufactured in Experimental Example 5 were evaluated. The evaluation methods were the same as in Comparative Example 1.

### 7. Experimental Example 6

### Manufacture of Lithium Battery

(Preparation of electrolyte composition) An electrolyte composition was prepared by adding about 2 wt% of a vinylidenefluoride-trifluoroethylenechlorotrifluoroethylene copolymer (p(VDF-TrFE-CTFE)) to the same electrolyte composition of Comparative Example 1.

(Manufacture of lithium battery) A lithium battery was manufactured by the same method as in Comparative Example 1 except for using the electrolyte composition above as the electrolyte composition.

### Evaluation

(Evaluation of electrolyte composition) The ionic conductivity of the electrolyte composition prepared in Experimental Example 6 was evaluated.

(Evaluation of lithium battery) The electrochemical stability, charge and discharge performance, output properties and life characteristics of the lithium battery manufactured in Experimental Example 6 were evaluated. The evaluation methods were the same as in Comparative Example 1.

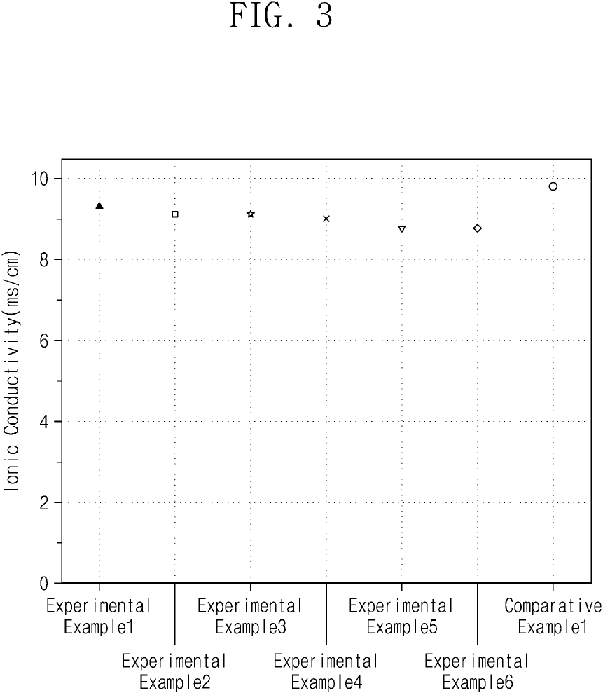

FIG. 3 is a diagram for explaining the ionic conductivity evaluation of the electrolyte compositions of Comparative Example 1, Experimental Example 1, Experimental Example 2, Experimental Example 3, Experimental Example 4, Experimental Example 5 and Experimental Example 6, and is a graph showing ionic conductivity according to the introduction of a polymer additive.

Referring to FIG. 3, it could be found that the electrolyte compositions of Experimental Example 1, Experimental Example 2, Experimental Example 3, Experimental Example 4, Experimental Example 5 and Experimental Example 6, introducing a polymer additive showed rarely reduced ionic conductivity when compared to the electrolyte composition of Comparative Example 1. That is, it could be confirmed that the polymer additive did not inhibit the ionic conductivity of lithium ions.

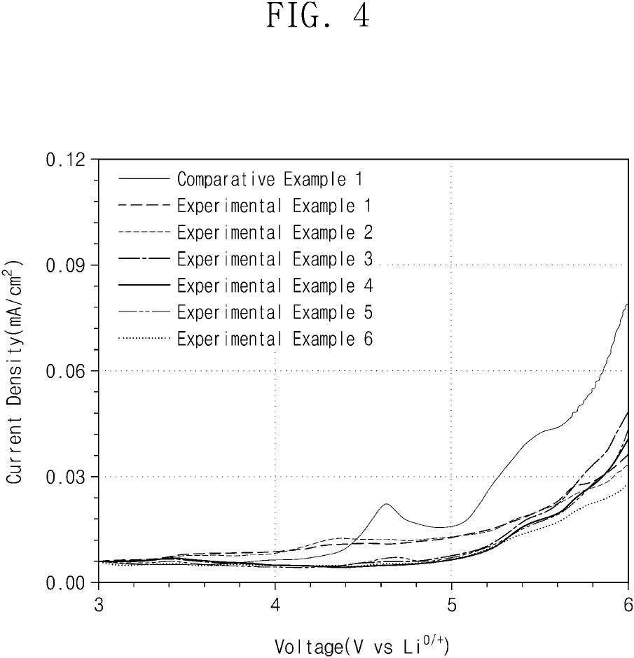

FIG. 4 is a diagram for explaining the electrochemical stability evaluation of the electrolyte compositions of Comparative Example 1, Experimental Example 1, Experimental Example 2, Experimental Example 3, Experimental Example 4, Experimental Example 5 and Experimental Example 6, and is a graph showing current density in accordance with voltages for each electrolyte composition.

Referring to FIG. 4, it could be confirmed that the electrolyte compositions of Experimental Example 1, Experimental Example 2, Experimental Example 3, Experimental Example 4, Experimental Example 5 and Experimental Example 6, introducing a polymer additive obtained the same electrochemical oxidation current (based on about 0.3 mA cm⁻²) at a higher voltage when compared to the electrolyte composition of Comparative Example 1, not introducing a polymer additive. It could be found that electrochemical side reactions did not occur according to the introduction of a polymer additive, and high voltage stability was improved.

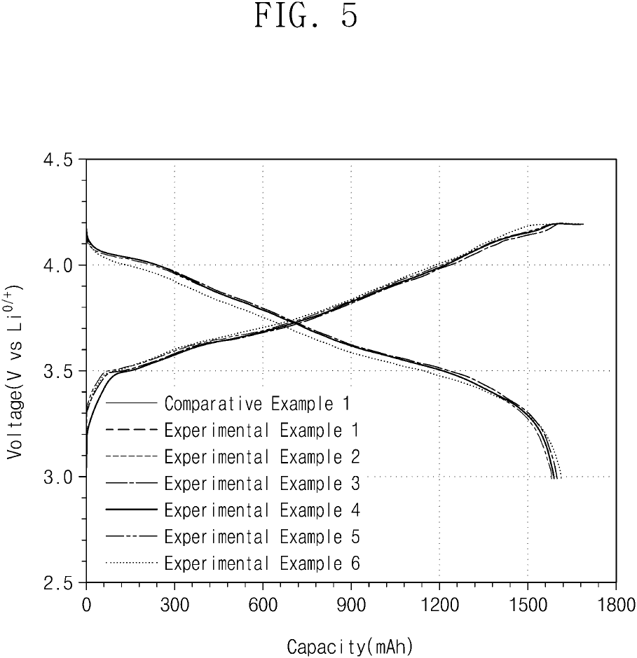

FIG. 5 is a diagram for explaining the initial charge and discharge performance property evaluation of the lithium batteries of Comparative Example 1, Experimental Example 1, Experimental Example 2, Experimental Example 3, Experimental Example 4, Experimental Example 5 and Experimental Example 6, and is a graph showing voltages in accordance with discharge capacity of lithium batteries.

Referring to FIG. 5, it could be confirmed that the discharge capacity of the lithium batteries of Experimental Example 1, Experimental Example 2, Experimental Example 3, Experimental Example 4, Experimental Example 5 and Experimental Example 6, introducing a polymer additive showed not a significance difference when compared to the discharge capacity of the lithium battery of Comparative Example 1, not introducing a polymer additive.

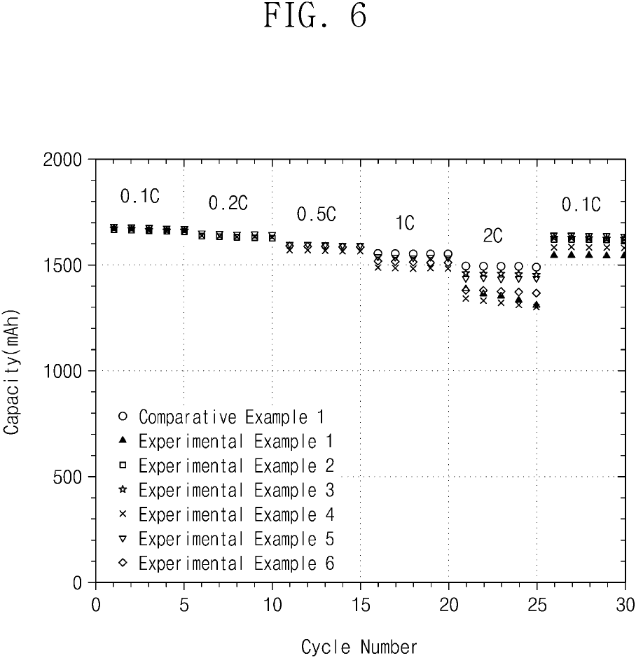

FIG. 6 is a diagram for explaining the output property evaluation of the lithium batteries of Comparative Example 1, Experimental Example 1, Experimental Example 2, Experimental Example 3, Experimental Example 4, Experimental Example 5 and Experimental Example 6, and is a graph showing capacity in accordance with cycle number.

Referring to FIG. 6, it could be confirmed that the 2 C charge and discharge basis capacity of the lithium batteries of Experimental Example 1, Experimental Example 2, Experimental Example 3, Experimental Example 4, Experimental Example 5 and Experimental Example 6, introducing a polymer additive showed a somewhat decreasing tendency when compared to the 2 C charge and discharge basis capacity of Comparative Example 1, but showed similar output properties up to about 1 C.

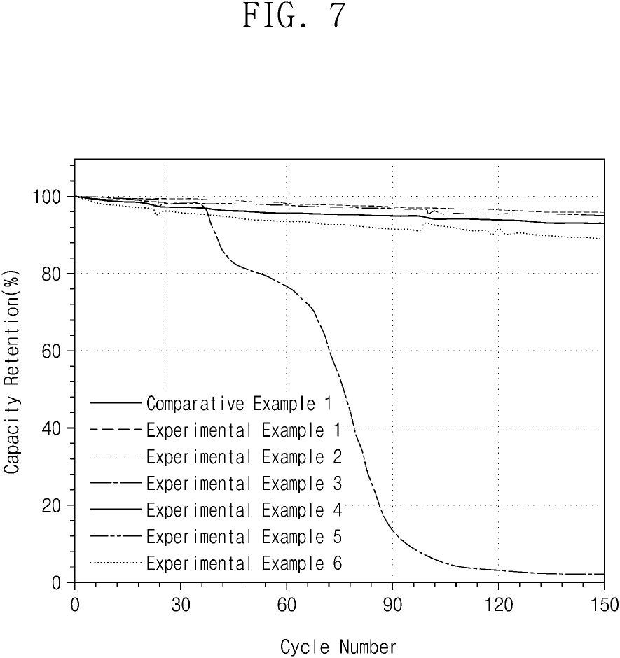

FIG. 7 is a diagram for explaining the cycle retention property evaluation of the lithium batteries of Comparative Example 1, Experimental Example 1, Experimental Example 2, Experimental Example 3, Experimental Example 4, Experimental Example 5 and Experimental Example 6, and is a graph showing capacity in accordance with cycle numbers.

Referring to FIG. 7, it could be confirmed that the life of the lithium batteries of Experimental Example 1, Experimental Example 2, Experimental Example 3, Experimental Example 4, Experimental Example 5 and Experimental Example 6, introducing a polymer additive showed similar characteristics as the lithium battery of Comparative Example 1, not introducing a polymer additive, except for Experimental Example 3 that showed deteriorated life characteristics.

Referring to FIG. 3 to FIG. 7, a polymer additive may not induce electrochemical side reactions in the operation voltage range of a lithium battery and may minimize the reduction of ionic conductivity, and the performance of the lithium may be maintained. Though a polymer additive is introduced, there may be not much change of the output properties and life characteristics of the lithium battery. In addition, the polymer additive has excellent dissolution and may be dispersed uniformly in an electrolyte, and accordingly, flame retardant properties may be improved. The polymer additive may improve the defects of a combustible liquid electrolyte and may improve the safety of a lithium battery.

According to the inventive concept, an electrolyte composition and a lithium battery including the same may improve thermal safety properties. The lithium battery may show improved electrochemical properties.

Although the embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. A lithium battery comprising:
a first electrode structure;
a second electrode structure separated from the first electrode structure; and
an electrolyte between the first electrode structure and the second electrode structure,
wherein the electrolyte comprises:
a lithium salt;
an organic solvent; and
an additive,
the additive comprises a polymer additive, and
the polymer additive is a mixture of at least two or more polymers among a halogen-based polymer, a silicon-based polymer and an acrylic polymer, or a copolymer thereof.

2. The lithium battery of claim 1, wherein
the halogen-based polymer is a polymer in which at least one hydrogen atom of a polyolefin polymer main chain is substituted with at least one among F, Cl, Br and I, or a copolymer thereof,
the silicon-based polymer is a polymer comprising a main chain of a polysiloxane type, or a copolymer thereof, and
the acrylic polymer is a polymer comprising acrylate in a unit, or a copolymer thereof.

3. The lithium battery of claim 1, wherein the silicon-based polymer is represented by Formula 1: 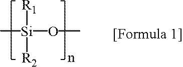
in Formula 1, R₁ and R₂ are each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

4. The lithium battery of claim 1, wherein the acrylic polymer is represented by Formula 2: 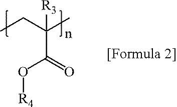
in Formula 2, R₃ and R₄ are each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

5. The lithium battery of claim 1, wherein a composition ratio of the polymer additive is from about 0.1 wt% to about 30 wt% of the electrolyte.

6. The lithium battery of claim 1, wherein a molecular weight of the polymer additive is from about 500 g/mol to about 10,000,000 g/mol.

7. The lithium battery of claim 1, wherein the polymer additive is added in a powder type to the electrolyte.

8. The lithium battery of claim 1, wherein the additive further comprises an auxiliary agent, and
the auxiliary agent is at least one of ethylene carbonate or vinylene carbonate or combination thereof.

9. The lithium battery of claim 1, wherein
the first electrode structure comprises a first collector and a first electrode layer on the first collector, and
the first electrode layer is provided between the first collector and the electrolyte.

10. The lithium battery of claim 9, wherein the second electrode structure comprises a second collector and a second electrode layer on the second collector, and
the second electrode layer is provided between the second collector and the electrolyte.

11. The lithium battery of claim 1, wherein the lithium battery further comprises a separator between the first electrode structure and the second electrode structure, and
the electrolyte is provided between the first electrode structure and the separator, and between the second electrode structure and the separator.

12. An electrolyte composition comprising:
a lithium salt;
an organic solvent; and
an additive, wherein
the additive comprises a polymer additive, and
the polymer additive is a mixture of at least two or more polymers among a halogen-based polymer, a silicon-based polymer and an acrylic polymer, or a copolymer thereof.

13. The electrolyte composition of claim 12, wherein
the halogen-based polymer is a polymer in which at least one hydrogen atom of a polyolefin polymer main chain is substituted with at least one among F, Cl, Br and I, or a copolymer thereof,
the silicon-based polymer is a polymer comprising a main chain of a polysiloxane type, or a copolymer thereof, and
the acrylic polymer is a polymer comprising acrylate in a unit, or a copolymer thereof.

14. The electrolyte composition of claim 12, wherein the silicon-based polymer is represented by Formula 1: 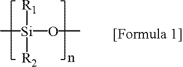
in Formula 1, R₁ and R₂ are each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

15. The electrolyte composition of claim 12, wherein the acrylic polymer is represented by Formula 2: 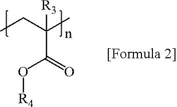
in Formula 2, R₃ and R₄ are each independently hydrogen, an alkyl group of 1 to 6 carbon atoms, a fluoroalkyl group of 1 to 6 carbon atoms, an aryl group of 6 to 10 carbon atoms, a fluoro group, a nitro group, an amino group or a cyano group.

16. The electrolyte composition of claim 12, wherein a composition ratio of the polymer additive in the electrolyte composition is from about 0.1 wt% to about 30 wt%.

17. The electrolyte composition of claim 12, wherein a molecular weight of the polymer additive is from about 500 g/mol to about 10,000,000 g/mol.

18. The electrolyte composition of claim 12, wherein the polymer additive is added in a powder type.

19. The electrolyte composition of claim 12, wherein the additive further comprises an auxiliary agent, and
the auxiliary agent is at least one of ethylene carbonate or vinylene carbonate or combination thereof.

20. The electrolyte composition of claim 12, wherein the polymer additive comprises at least one of a vinylidenefluoride-hexafluoropropylene copolymer (p(VDF-co-HFP)), polymethylmethacrylate (PMMA), polydimethylsiloxane (PDMS), vinylidenefluoride-trifluoroethylene copolymer (p(VDF-TrFE)), or vinylidenefluoride-trifluoroethylene-chlorotrifluoroethylene copolymer (p(VDF-TrFE-CTFE)) or combination thereof.
